(19) United States
(12) Patent Application Publication
(10) Pub. No.: US 2009/0222271 A1
(43) Pub. Date: Sep. 3, 2009

(54) Method For Operating A Navigation System

(76) Inventor: Jochen Katzer, Gallmersgarten-Bargtshofen (DE)

Correspondence Address: QUARLES & BRADY LLP, 411 E. WISCONSIN AVENUE, SUITE 2040, MILWAUKEE, WI, 53202-4497, US

(21) Appl. No.: 12/388,385

(22) Filed: Feb. 18, 2009

(30) Foreign Application Priority Data
Feb. 29, 2008 (DE) 10 2008 012 065.0
Jun. 13, 2008 (DE) 10 2008 028 090.9

(51) Int. Cl. G10L 15/22

(52) U.S. Cl. 704/275; 704/E15.04

(57) ABSTRACT

A method for operating a navigation system analyzes several address components to determine the most likely address desired by a user. The navigation device includes a receiving device on which an acoustic address input consisting of several input components can be registered. The input components of the address are analyzed with a speech recognition module, wherein at least one geographical location, which is defined by an address with several address components, is selected from a database for further processing depending on the result of the speech recognition analysis. The method includes analyzing several address component combinations to determine the most likely address inputted by the user.

This application claims the priority benefit of German Patent Application No. 10 2008 012 065.0 filed on Feb. 29, 2008, and German Patent Application No. 10 2008 028 090.9 filed on Jun. 13, 2008, the contents of which are hereby incorporated by reference as if fully set forth herein in their entirety.

### STATEMENT CONCERNING FEDERALLY SPONSORED RESEARCH OR DEVELOPMENT

Not applicable.

### FIELD OF THE INVENTION

The invention relates to a method for operating a navigation system including a receiving device on which an acoustic address input consisting of several input components can be registered, wherein the input components of the address are analyzed with a speech recognition module, and wherein at least one geographical location, which is defined by an address with several address components, is selected from a database for further processing depending on the result of the speech recognition analysis.

### BACKGROUND OF THE INVENTION

Known navigation systems are equipped with speech recognition systems to enable the user to make certain inputs, particularly addresses, by audible means. In other words, this means that in the case of these navigation systems with a speech recognition system, the address no longer has to be entered alphanumerically via a keyboard or at a touch-screen, instead the various input components of the address are spoken into a receiving device, particularly a microphone. These acoustic inputs can then be analyzed by speech analysis in a speech recognition module and can be assigned to a geographical location stored in a database, the location being defined by an address with the corresponding address components. This geographical location is then selected from the database and is used for further processing, for example route planning. In the voice-controlled address recognition method of known navigation systems, it is common practice that the various input components of the address, for example the name of the town, the name of the street, and the house number, are entered separately and analyzed sequentially. This means that, for example, the name of a town is spoken by speech input first, and is registered acoustically, then a list of confirmed hits is compiled from all the town names by speech analysis. The user then selects a town either verbally or manually. Then, a street name can be registered and analyzed by speech input and selected by speech analysis. Finally, the house number is also recorded acoustically, speech analysis is performed and the user makes a final selection.

The drawback in this known method for identifying an address by speech input is that it requires a number of interactions between the user and the navigation system. For example, each individual input of the various input components of the address must be confirmed, If the desired option is not displayed in the first position in a selection list, the user also has to look at the display of the navigation system up to three more times in order to select the correct option. As a result, the total time taken to complete the input process is relatively long. Moreover, the user's attention is diverted significantly, which may lead to hazardous situations, particularly in traffic.

### SUMMARY OF THE INVENTION

In the context of this prior art, the object of the present invention is therefore to provide a new method for operating a navigation system in which the number of interactions for inputting an address by audible means and for the speech analysis is reduced, and the time required to complete the input is shortened.

This object is achieved by one method incorporating the invention in which a speech recognition analysis is performed for a first input component, wherein several possible first address components are selected from the database depending on the result of the speech recognition analysis for the first input component, and wherein a match value is calculated for each of these alternative first address components to quantify the acoustic match with the first input component; a speech recognition analysis is performed for at least a second input component, wherein several possible second address components are selected from the database depending on the result of the speech recognition analysis for the second input component, and wherein a match value is calculated for each of these alternative second address components to quantify the acoustic match with the second input component; a combination evaluation is calculated for each of the various combinations of each different first and second address component, which combination evaluation is based on the match values of the address components in various combinations with each other.

The basis for the method incorporating the invention is that a speech recognition analysis is performed for at least two input components of the acoustic address input. Depending on the result of this speech recognition analysis, several possible first address components for the first input component are then selected from the database, and several possible second address components for the second input component are selected from the database. In addition, a match value to quantify the acoustic match with the first and then the second input component is calculated for each of the alternatives for the first and then the second address component. This match value thus characterizes the probability that the respective address component matches the input component for the address entered verbally by the user.

After a speech recognition analysis has been performed for at least two input components of this nature and the respective acoustic match values have been calculated, several different combinations are created from the different first and second address components that were determined in this speech analysis, and a combination evaluation is assigned to each of these combinations. This combination evaluation is based on the acoustic match values assigned to each of the address components.

With this novel combination evaluation, the match values that are determined by speech recognition analysis no longer have to be processed sequentially, one after the other, instead they are considered together in an overall evaluation, which is to say the combination evaluation. The interactions that are required in order to enter an entire address and the associated input time are significantly reduced thereby. The probability of obtaining a hit is also increased considerably by combining the evaluation of the speech recognition results for all input components, which in turn means that fewer user interactions are necessary to correct the address input.

In general, the results produced by a method incorporating the invention using combination evaluation may be processed further as required. According to a first preferred variant of the method, the combination of address components with the best combination evaluation is selected for further processing. For example, this combination, which has the highest likelihood of being a hit according to the combination evaluation, may be displayed to the user for selection and confirmation.

Alternatively or in addition thereto, a list may also be compiled from a number of address component combinations. Each of the combinations included in the list has the highest combination evaluation in relative terms, and thus also the highest likelihood in relative terms of being a perfect match. The user may then select and confirm for example the address he actually wants from this list.

In order to make it easy for the user to select and confirm in this way, the list compiled from multiple combinations of address components may be output, particularly displayed, for the user.

The input components that make up an address input often depend on the typical conditions in a given country. In most countries, however, inputting the name of a town, the name of a street and a house number is sufficient to unambiguously identify an address within a specific geographical region, for example a national state.

In this context, it is particularly advantageous if the navigation system prompts the user to enter the name of the town and/or the name of the street and/or the house number one after the other. The various input components may be entered essentially in any order.

According to a preferred variant of the method, the probability that the method incorporating the invention may produce a hit may be increased even further in the speech recognition analysis. In this method variant, each combination of a first input component and a second input component is examined to determine whether the second input component has been identified as being associated with the first input component, and all combinations in which the second input component has not been identified as being associated with the first input component are rejected. This method variant may also be refined so that from the start the search for a hit for the second input component, for example the street name, is performed only for the second address component that has been associated with the first input component, for example a given town.

According to a preferred variant, each combination of a possible town name and a possible street name is examined to determine whether this street name even exists in the town in question. If this analysis concludes that there is no such street in the town in question, the combination is rejected at the start, since it is ultimately irrelevant.

According to a further extension of this method variant, each combination of a street name and a house number may be examined to determine whether the house number actually exists on the street in question. If there is no such house number on the street in question, this combination is also rejected, since any possible result based on this combination is evidently irrelevant.

Depending on the linguistic customs in different countries, it may be advantageous to enter the various input components in a different order. In order to reflect this appropriately, it is particularly advantageous if the order of the various input components for the acoustic address input has been configured by user setting so that one is able to respond variably to the various practices typical in different countries.

As an alternative to pre-configuring the sequence of the various input components, it is also conceivable that the various input components of the acoustic address input may be analyzed to determine which categories of input components are contained in the input, particularly with regard to the input of town names, street names or house numbers. This additional speech analysis thus enables a full input to be divided into the various input components in the corresponding categories.

The following is an exemplary explanation of one possible embodiment for application of a method incorporating the invention. According to this method variant, the process is as follows:

### DETAILED DESCRIPTION OF THE PREFERRED EMBODIMENT

A method incorporating the present invention is suitable for operating a navigation system. Preferably, the navigation device includes a receiving device on which an acoustic address input consisting of several input components can be registered. The input components of the address are analyzed with a speech recognition module forming part of the navigation device, and wherein at least one geographical location, which is defined by an address with several address components, is selected from a database for further processing depending on the result of the speech recognition analysis. The database can be stored in memory forming part of the navigation system.

In a preferred embodiment, the method can include the following steps:
1. The user enters the name of a town.
2. Based on speech analysis, the navigation system identifies a number of possible hits for this entry of a town name from all of the towns in a pre-selected region, for example a given country, e.g., Germany. An acoustic match value characterizing the probability that the speech recognition analysis has identified a match is assigned to each of these hits.
3. The system creates a combined street list containing all the streets for all possible hits for the town that was input.
4. The system prompts the user to input a street name.
5. The user verbally inputs a street name.
6. The navigation system identifies a number of possible hits for this street input by speech recognition analysis, and only streets from the town list calculated previously are considered so that all combinations that are irrelevant from the start are already excluded.
7. The system prompts the user to input a house number.
8. The user verbally inputs a house number.
9. The navigation system identifies a possible house number by speech recognition analysis.
10. The system now compares the town list and the street list, an acoustic match value having been assigned to each element of both lists. A combination evaluation is then calculated by combination evaluation from the respective acoustic match values for all combinations of the town names and street names contained in the lists. The combination of a town name and a street name with the highest combination evaluation, i.e. the highest probability product from the acoustic match value of the town name and the acoustic match value of the street name, is offered as the best hit.

The order of the different input components is essentially inconsequential for the function of the method, in particular the house number may be entered before the street name. As a variant of the technical implementation described above for exemplary purposes, it would be possible to carry out the entire acoustic input first, and compile the respective lists afterwards, taking into account the different acoustic match values. The method is freely configurable, so that it may be adapted to the customary practices of the user. Thus for example, American addresses may be input as follows: “7, Main Street, Chicago, Ill”.

The method as described above will now be explained in greater detail with the aid of an example. In this example, the user speaks the name of the town “Würzburg” into the navigation system's receiving device, such as a microphone. By speech recognition analysis, the navigation system identifies the following towns, each followed by its acoustic match value, which characterizes the probability that it is a hit:
Wurzbach match value 89%
Würzberg match value 83%
Würzburg match value 72%
Wurzberg match value 65%

The navigation system then compiles a common list of all the streets in each of these towns. When prompted by the system, the user then speaks the name of the street “Berliner Platz” into the navigation system's receiving device. By speech recognition analysis, the system identities the following streets from the street list it has compiled, each followed by its associated acoustic match value:
Berlingplatz match value 95%
Berliner Platz match value 87%
Berner Platz match value 63%

The navigation system now compares the possible hit combinations:
“Berlingplatz” only exists in “Wurzberg”, which means that all other combinations with Berlingplatz may be rejected without further examination. The combination of “Berlingplatz” and “Wurzberg” yields a combination evaluation of 65%×95%=61.75%.
“Berliner Platz” only exists in “Würzburg”, which means that all other combinations may be rejected immediately in this case, too. The combination evaluation of the combination of “Würzburg” and “Berliner Platz” yields a value of 72%×87%=62.64%.
“Berner Platz” exists in two towns, “Wurzbach” and “Würzburg”. The combination of “Berner Platz” and “Wurzbach” yields a combination evaluation of 89%×63%=56.07%. The combination of “Berner Platz” and “Würzburg” yields a combination evaluation of 72%×63%=45.36%.

After the combination evaluation has been performed, the following ranking is produced for the possible addresses:
Position 1: Würzburg, Berliner Platz, combination evaluation 62.64%
Position 2: Wurzberg, Berlingplatz, combination evaluation 61.75%
Position 3: Wurzbach, Berner Platz, combination evaluation 56.07%
Position 4: Würzburg, Berner Platz, combination evaluation 45.36%

As a result, the user is then offered the address “Würzburg, Berliner Platz” and the best hit, even though the town name “Würzburg” was only assigned a match value of 72% and third position in the speech recognition analysis. Advantageously, this inventive method transforms audible speech into a selected address while reducing both the time required for inputting the address by audible means and analysis of the speech. The selected address can then be offered to the user by displaying the selected address on a display screen forming part of the navigation device and/or announced to the user via a speaker forming part of the navigation device.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

1. A method for operating a navigation system, including a receiving device on which an acoustic address input consisting of several input components can be registered, wherein the input components of the address are analyzed with a speech recognition module, and wherein at least one geographical location, which is defined by an address with several address components, is selected from a database for further processing depending on the result of the speech recognition analysis, said method comprising:
a) a speech recognition analysis is performed for a first input component, wherein several possible first address components are selected from the database depending on the result of the speech recognition analysis for the first input component, and wherein a match value is calculated for each of these alternative first address components to quantify the acoustic match with the first input component;
b) a speech recognition analysis is performed for at least a second input component, wherein several possible second address components are selected from the database depending on the result of the speech recognition analysis for the second input component, and wherein a match value is calculated for each of these alternative second address components to quantify the acoustic match with the second input component;
c) a combination evaluation is calculated for each of the various combinations of each different first and second address component, which combination evaluation is based on the match values of the address components in various combinations with each other.

2. The method according to claim 1, in which the combination of address components with the best combination evaluation is selected for further processing.

3. The method according to claim 1, in which a list of several combinations of address components that have the relatively highest combination evaluations is selected for further processing.

4. The method according to claim 1, in which the list of several combinations of address components that have the relatively highest combination evaluations is output, particularly displayed, so that the user can select an address.

5. The method according to claim 1, in which the user is prompted to input the name of a town and the user's answer is registered and analyzed acoustically as an input component, and/or that the user is prompted is prompted to input the name of a street and the user's answer is registered and analyzed acoustically as an input component, and/or that the user is prompted to input a house number and the user's answer is registered and analyzed acoustically as an input component.

6. The method according to claim 1, in which each combination of a first input component and a second input component is examined to determine whether the second input component has been identified as being associated with the first input component, wherein all combinations in which the second input component has not been identified as being associated with the first input component are rejected.

7. The method according to claim 6, in which each combination of a town name and a street name is examined to determine whether the street name in question exists in the town in question, wherein all combinations in which the street does not exist in the town in question are rejected.

8. The method according to claim 6, in which each combination of a street name and a house number is examined to determine whether the house number in question exists on the street in question, wherein all combinations in which the street in question does not include such a house number are rejected.

9. The method according to claim 1, in which the order of the various input components of the acoustic address input is configured by user setting.

10. The method according to claim 1, in which various input components of the acoustic address input are analyzed, and individual input components are assigned to various categories, in particular a town name and/or a street name and/or a house number, depending on the result of the analysis.

11. A method for operating a navigation system, including a receiving device on which an acoustic address input consisting of several input components can be registered, wherein the input components of the address are analyzed with a speech recognition module, and wherein at least one geographical location, which is defined by an address with several address components, is selected from a database for further processing depending on the result of the speech recognition analysis, said method comprising:
a) receiving an audible first input component in the receiving device of the navigation device;
b) performing a speech recognition analysis for the first input component using the speech recognition module, wherein several possible first address components are selected from the database depending on the result of the speech recognition analysis for the first input component;
c) calculating a match value for each of these alternative first address components to quantify the acoustic match with the first input component;
d) receiving an audible second input component in the receiving device of the navigation device;
e) performing a speech recognition analysis for the second input component using the speech recognition module, wherein several possible second address components are selected from the database depending on the result of the speech recognition analysis for the second input component;
f) calculating a match value for each of these alternative second address components to quantify the acoustic match with the second input component;
g) calculating a combination evaluation for each of the various combinations of each different first and second address component, which combination evaluation is based on the match values of the address components in various combinations with each other;
h) selecting the combination of first and second address components having the highest combination evaluation; and
g) offering the selected combination of first and second address components having the highest combination evaluation to a user via at least one of visual display and audible announcement.
